(19) United States
(12) Patent Application Publication
(10) Pub. No.: US 2009/0025755 A1
(43) Pub. Date: Jan. 29, 2009

(54) Method for treating substrate

(75) Inventors: Dae-Hong Eom, Yongin-si (KR); Chang-Ki Hong, Seongnam-si (KR); Woo-Gwan Shim, Yongin-si (KR); Young-Ok Kim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/219,562

(22) Filed: Jul. 24, 2008

(30) Foreign Application Priority Data
Jul. 24, 2007 (KR) 10-2007-0074206

(51) Int. Cl. B08B 3/10

(52) U.S. Cl. 134/30

(57) ABSTRACT

Example embodiments relate to a method of treating a substrate after performing a cleaning step with a liquid chemical in a single substrate spin cleaner. A method of treating a substrate according to example embodiments may include forming a film of deionized water on a surface of the substrate during rinsing, and drying the substrate by supplying a drying gas to the water film on the surface of the substrate. When rinsing the substrate, the rotating speed of the substrate may be reduced to about 50 rpm or less to form a film of water on the surface of the substrate. The film of water may shield the surface of the substrate from direct exposure to atmospheric air. The film of water may be maintained on the surface of the substrate when commencing the supply of the drying gas. Consequently, the number of water marks on the dried substrate may be reduced or prevented.

### PRIORITY STATEMENT

This application claims priority under 35 U.S.C. §119 to Korean Patent Application No. 10-2007-0074206, filed on Jul. 24, 2007 with the Korean Intellectual Property Office (KIPO), the entire contents of which are incorporated herein by reference.

### BACKGROUND

1. Technical Field

Example embodiments relate to a method for manufacturing a semiconductor device.

2. Description of the Related Art

Liquid chemicals are conventionally used in a cleaning process during semiconductor manufacturing. A conventional semiconductor manufacturing method includes rinsing the liquid chemicals used in the last stage of a cleaning process from a surface of a substrate with deionized water, followed by drying. However, properly drying the surface of the substrate after rinsing is more difficult when the liquid chemical is a hydrofluoric acid (HF) solution.

A conventional batch-type cleaner includes a marangonic or isopropyl alcohol (IPA) vapor dryer capable of performing a drying operation while preventing the occurrence of a water mark, regardless of surface characteristics of the substrate (e.g., hydrophilicity, hydrophobicity, presence of a pattern). On the other hand, a conventional single-type spin cleaner uses centrifugal force to clean, rinse, and dry a substrate. As a result, a water mark may still occur during a drying operation, depending on surface characteristics of the substrate (e.g., hydrophilicity, hydrophobicity, presence of a pattern). The occurrence of water marks is even more likely when HF solution is used in the last stage of a substrate-cleaning process. Thus, single-type spin cleaners are conventionally used in processes that are less affected by the occurrence of water marks (e.g., strip processes, standard clean 1 (SC1) cleaning processes). Although improved single-type spin cleaners have been developed, the drying characteristics of single-type spin cleaners are still considered less effective than those of batch-type cleaners, at least with regard to preventing the occurrence of water marks.

### SUMMARY

A method of treating a substrate may include rinsing a surface of the substrate with water while rotating the substrate at a first speed followed by a second speed. The surface of the substrate may be rinsed with deionized water. The substrate may be dried by supplying a drying gas onto the surface of the substrate while rotating the substrate at a third speed of about 50 rpm or less.

The first speed may facilitate the dispersion of water from the surface of the substrate. The first speed may range from about 500-600 rpm. The second speed may facilitate the formation and maintenance of a film of water on the surface of the substrate. The second speed may be equal to the third speed. The film of water may completely cover the surface of the substrate. Additionally, the film of water may shield the surface of the substrate from direct exposure to atmospheric air.

Rinsing the surface of the substrate may include reducing the rotation of the substrate from a first speed to a second speed prior to completion of the rinsing to form a film of water on the surface of the substrate. The substrate may be rotated at the second speed for about 5-10 seconds preceding completion of the rinsing. The film of water may be maintained on the surface of the substrate when commencing the drying of the substrate.

Drying the substrate may include supplying the drying gas onto the surface of the substrate along a path extending from a center of the substrate to an edge of the substrate. The drying gas may be supplied with a drying nozzle while moving the drying nozzle from the center of the substrate to the edge of the substrate. The drying nozzle may be moved at a speed ranging from about 1-2 mm/s. The drying nozzle may be moved at about 1 mm/s in a center portion of the substrate and at about 2 mm/s in an edge portion of the substrate. The drying gas may include a mixture of an isopropyl alcohol (IPA) nano mist and a carrier gas. The IPA may be supplied at a flow rate of about 30 ml/min, and the carrier gas may be supplied at a flow rate of about 10 l/min. The drying gas may be supplied at a pressure ranging from about 1.5-3.5 g_{f}/cm².

### BRIEF DESCRIPTION OF THE FIGURES

FIG. 1 is a schematic view of a spin dryer according to example embodiments.

FIG. 2 is a flowchart of a method of treating a substrate according to example embodiments.

FIG. 3 is a side view of a drying process using a spin dryer according to example embodiments.

FIG. 4 is a plan view of various substrates illustrating the decreased number of water marks remaining on the substrates after being dried according to example embodiments.

FIG. 5 is a plan view of various substrates illustrating the increased number of water marks remaining on the substrates after being dried under comparative conditions.

### DETAILED DESCRIPTION OF EXAMPLE EMBODIMENTS

Example embodiments of the present application are described in further detail below with reference to the accompanying drawings. However, the examples herein may be embodied in different forms and should not be construed to limit the scope of the present application. Like reference numerals refer to like elements throughout the specification.

It will be understood that when an element or layer is referred to as being “on”, “connected to”, “coupled to”, or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

A method of manufacturing a semiconductor device may include a cleaning process for removing contaminants (e.g., particles, organic materials, metals, oxide layers) that may have accumulated on a surface of a substrate during manufacturing. The cleaning process may have a rinsing aspect and a drying aspect. The rinsing aspect of the cleaning process may include rinsing a surface of a substrate with deionized water to remove chemicals that may have been used for cleaning and/or etching the substrate. A film of water may be formed on the substrate. The drying aspect of the cleaning process may include rotating the substrate at a relatively low speed while injecting a gas (e.g., nitrogen+isopropyl alcohol (IPA)) on the substrate. For example, a spin dryer may be utilized as a cleaner for the cleaning process.

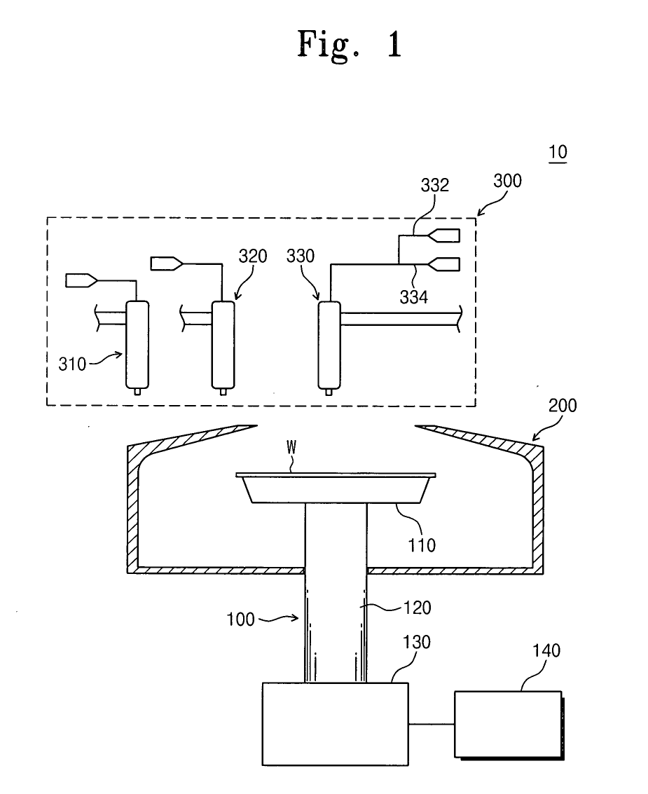

FIG. 1 is a schematic view of a spin dryer according to example embodiments. Referring to FIG. 1, a spin dryer 10 may include a support member 100, a catch cup 200, and an injection member 300.

The support member 100 may include a spin head 110 for supporting a substrate W (e.g., wafer) while processes are being performed. The spin head 10 may have a circular plate shape with a flat upper surface. The diameter of the spin head 110 may be similar to that of the substrate W. The substrate W may be disposed on the spin head 110 such that the surface to be treated faces upward. The support member 100 may also include a rotation shaft 120 and a spin motor 130. The rotation shaft 120 may support the spin head 110 while transmitting a rotational force. The spin motor 130 may provide the rotation shaft 120 with the rotational force. The spin motor 130 may be controlled by a controller 140. The spin motor 130 may be operated at a relatively high speed or a relatively low speed by virtue of the controller 140. Thus, the centrifugal force generated by the rotation of the spin head 110 may vary with the operating speed of the spin motor 130. Liquid on the surface of the substrate W may be removed by the centrifugal force.

The support member 100 may include a conventional lift pin (not shown) for receiving and loading the substrate W on the spin head 110 from a transfer robot (not shown) transferring the substrate W. Although not shown, the spin head 110 may hold onto the substrate W by means of vacuum or mechanical clamping during processing. A plurality of guide pins (not shown) may also be disposed near or at the edge of the spin head 110 so as to prevent the wafer W from falling off the spin head 110 during processing.

The catch cup 200 may be disposed to surround the spin head 110. The catch cup 200 may reduce or prevent the splattering of fluids that may have been supplied to the substrate W during cleaning and/or rinsing. Thus, the area surrounding the catch cup 200 (which may include other apparatus) may be kept in a cleaner state.

Although not shown, the catch cup 200 and the spin head 110 may be configured to be moveable in a vertical manner relative to each other. The vertical movement of the catch cup 200 and/or the spin head 110 may facilitate the loading of the substrate W into the catch cup 200 and the unloading of the substrate W from the catch cup 200 after processing.

The injection member 300 may be disposed above the spin head 110. The injection member 300 may include a cleaning nozzle 310, a rinsing nozzle 320, and a drying nozzle 330. The cleaning nozzle 310, rinsing nozzle 320, and drying nozzle 330 may be configured to inject treating fluids onto the surface of the substrate W. For example, the cleaning nozzle 310, rinsing nozzle 320, and drying nozzle 330 of the injection member 300 may be disposed at or near the center of the substrate W for injecting a cleaning solution, rinsing solution, and drying gas, respectively, onto the surface of the substrate W. Alternatively, the cleaning nozzle 310, rinsing nozzle 320, and drying nozzle 330 may be configured to move from the central region of the substrate W toward the edge of the substrate W while injecting the cleaning solution, rinsing solution, and drying gas, respectively, onto the surface of the substrate W. The cleaning nozzle 310, rinsing nozzle 320, and drying nozzle 330 of the injection member 300 may include moving units (not shown) that facilitate their joint or individual movements.

The cleaning nozzle 310 may supply a liquid chemical onto the substrate W to remove contaminants that may have accrued on the substrate W during manufacturing (e.g., etching, delaminating). The cleaning nozzle 310 may supply a variety of suitable liquid chemicals (either individually or in combination) depending on the contaminants to be removed. The rinsing nozzle 320 may supply a rinsing solution onto the substrate W to remove the liquid chemical from the substrate W. Deionized water may be used as the rinsing solution.

When injecting the liquid chemical and the rinsing solution, the cleaning nozzle 310 and the rinsing nozzle 320 may be disposed at or near the center of the substrate W. While the liquid chemical or the rinsing solution is being injected, the substrate W may be rotated. As a result, the liquid chemical or the rinsing solution may spread from the central region of the substrate W toward the edge of the substrate W by action of the centrifugal force. The substrate W may be rotated a relatively low speed near the end of the rinsing step such that the rinsing solution (e.g., deionized water) may form a film on the surface of the substrate W. Thus, prior to initiating the drying step which follows the rinsing step, the surface of the substrate W may be isolated from the atmospheric air by the film. The film may be removed using a relatively low centrifugal force in combination with a drying gas injected onto the substrate W during the drying step.

During the drying step, the drying nozzle 330 may supply a drying gas onto the substrate W while the drying nozzle 330 moves from the center of the substrate W toward the edge of the substrate W. The drying gas may be one type of gas or a mixture of gases. A drying gas mixture may include an organic solvent and an inert gas as a carrier gas. For example, the organic solvent may be isopropyl alcohol (IPA), and the inert gas may be nitrogen gas. Alternatively, the organic solvent may be one or more of ethyl glycol, 1-propanol, 2-propanol, tetrahydrofurane, 4-hydroxy-4-metyl-2-pentamone, 1-butanol, 2-butanol, methanol, ethanol, acetone, n-propyl alcohol, and dimethylether. Additionally, the inert gas may be a chemically stable gas other than nitrogen gas. The organic solvent may be soluble in the cleaning solution and may have a relatively low surface tension.

When IPA is used as the organic solvent, the drying nozzle 330 may employ a nano mist dryer (NMD) method to heat the IPA. As a result, heated IPA may be injected onto the substrate W in a mist form at a relatively high concentration to dry the surface of the substrate W. The IPA may reduce the surface tension of the film of deionized water on the substrate W such that the deionized water may be removed with greater ease. The removal of the deionized water from the substrate W may also be facilitated by the Marangoni effect, which is caused by a difference in surface tension between the IPA and the deionized water.

A first supply pipe 332 and a second supply pipe 334 may be connected to the drying nozzle 330. The first supply pipe 332 may supply an IPA nano mist, while the second supply pipe 334 may supply a nitrogen gas. Each of the first and second supply pipes 332 and 334 may include a valve (not shown) that is configured to open and close an inner channel so as to control the amount of fluid in the pipes.

Cleaning, rinsing, and drying the substrate W with the spin dryer of FIG. 1 will now be described in further detail below. For purposes of clarity, the following description will continue to make references to FIG. 1.

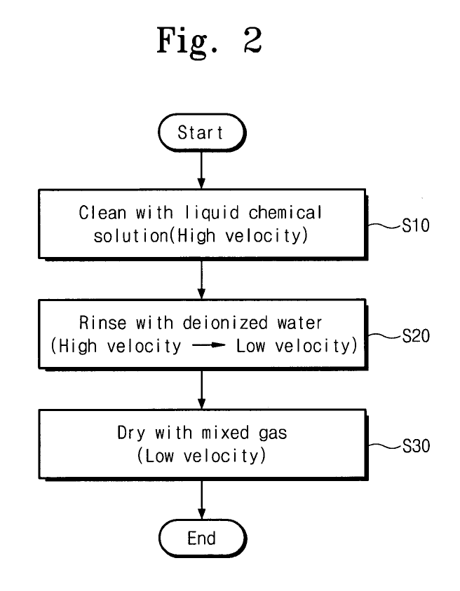

FIG. 2 is a flowchart of a method of treating a substrate according to example embodiments. As discussed above, the drying gas may be a mixture of an organic solvent and an inert gas, wherein IPA may be used as the organic solvent, and nitrogen gas may be used as the inert gas. Operation S10 may be representative of a cleaning step of the method. Operation S20 may be representative of a rinsing step of the method. Operation S30 may be representative of a drying step of the method.

In operation S10, the substrate W may be placed on the spin head 110 of the support member 100 by a transfer robot (not shown). A liquid chemical may be supplied by the cleaning nozzle 310 onto the center of the substrate W while the substrate W is being rotated at a relatively high speed. The liquid chemical may be distributed over the surface of the substrate W in response to the centrifugal force prior to being whirled off the substrate W. As a result, contaminants may be removed from the surface of the substrate W.

In operation S20, the liquid chemical remaining on the substrate W may be removed by supplying a rinsing solution through the rinsing nozzle 320 onto the center of the substrate W. The rinsing may include a first part and a second part. The first part may include supplying the rinsing solution (e.g., deionized water) onto the substrate W while the substrate W is being rotated at a speed ranging from about 500-600 rpm to remove the liquid chemical. The second part may include supplying the deionized water onto the substrate W while the substrate W is being rotated at a speed of about 50 rpm or less to form a film of water on the surface of the substrate W.

For example, the substrate W may be rotated at a speed ranging from about 500-600 rpm during the first part of the rinse. During the second part of the rinse, the rotating speed may be reduced to about 50 rpm or less (e.g., about 5-19 rpm) for about 5-10 seconds. As a result, the deionized water supplied to the substrate W may form and maintain a water film on the surface of the substrate W, as opposed to being whirled from the substrate W by the centrifugal force generated at higher speeds.

In operation S30, the water film may be removed by supplying a drying gas through the drying nozzle 330 onto the surface of the substrate W while the drying nozzle 330 is moved from the center of the substrate W toward the edge of the substrate W. The presence of a water film on the substrate W, the rotating speed of the substrate W, and the drying gas injected onto the substrate W are important parameters in the drying step. Thus, because the substrate W may be rotated at about 50 rpm or less (e.g., about 12 rpm), a water film may be maintained on the surface of the substrate W, without providing additional deionized water, prior to injection of the gas mixture to dry the substrate W.

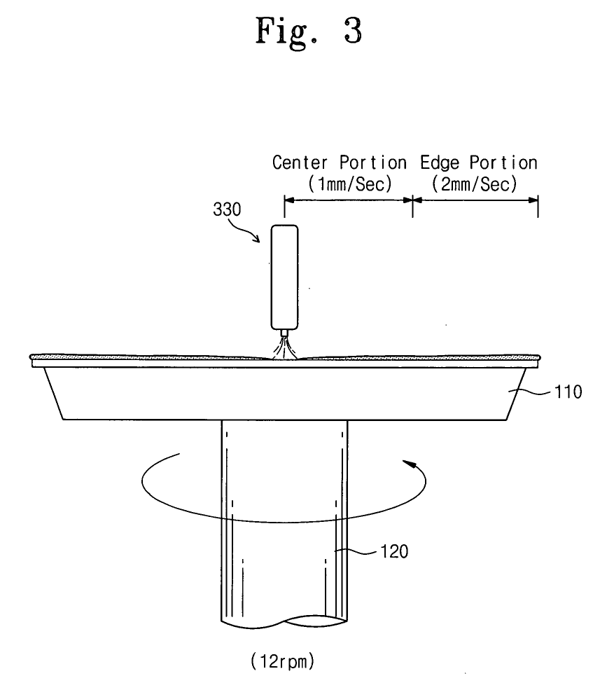

FIG. 3 is a side view of a drying process using a spin dryer according to example embodiments. Referring to FIG. 3, the substrate disposed on the spin head 110 may be a STI pattern wafer. The wafer may be rotated at about 12 rpm. IPA may be supplied to the wafer at about 30 ml/min. The drying nozzle 330 may be moved from the center of the wafer to the edge at varying speeds.

For example, the drying nozzle 330 may be moved at about 1 mm/s in a center portion of the wafer. The center portion may range from the center of the wafer to a distance of about 100 mm from the center. However, it should be understood that the size of the center portion may vary based on the overall size of the wafer. Additionally, the drying nozzle 330 may be moved at about 2 mm/s in an edge portion of the wafer. The edge portion may range from a distance of about 100 mm from the center of the wafer to a distance of about 150 mm from the center. Like the center portion, it should be understood that the size of the edge portion may vary based on the overall size of the wafer.

The drying gas injected through the drying nozzle 330 may be a gas mixture including nitrogen (N₂) gas and IPA. The nitrogen gas may have a flow rate of about 10 l/min, and the IPA may have a flow rate of about 30 ml/min. The supply line to the drying nozzle 330 may have a diameter of about ⅛ inch or less such that the gas mixture may be injected through the drying nozzle 330 at a relatively high pressure and velocity.

Drying of the wafer may be improved by ensuring that the surface of the wafer is covered by a film of water at the beginning of the drying step such that the water is removed by the drying gas supplied by the drying nozzle 330 rather than by centrifugal force. When the wafer is rotated at a speed greater than about 50 rpm, the water on the surface may disperse outward and away from the wafer before the surface can be dried by the drying gas from the drying nozzle 330. As a result, water marks may be formed on the dried surface of the wafer. Therefore, the occurrence of water marks may be reduced or prevented by rotating the wafer at a speed of about 50 rpm or less (e.g., about 20 rpm or less) during the drying step. Additionally, when the flow rate of the IPA in the gas mixture is greater than the operating range, a larger amount of contaminants may remain on the surface of the wafer. The IPA in the gas mixture injected from the drying nozzle 330 may be supplied at a flow rate of about 30 ml/min or less for an improved drying effect.

As described above, the gas mixture may include nitrogen gas at a flow rate of about 10 l/min and IPA at a flow rate of about 30 ml/min. The gas mixture injected through the drying nozzle 330 may have a pressure ranging from about 1.5 g_{f}/cm² to about 3.5 g_{f}/cm², which may be about 2 to 5 times greater than the drying gas pressure in a conventional drying process (e.g., about 0.6 g_{f}/cm²). However, it should be understood that the flow rate and pressure of the gas mixture may vary depending on process conditions.

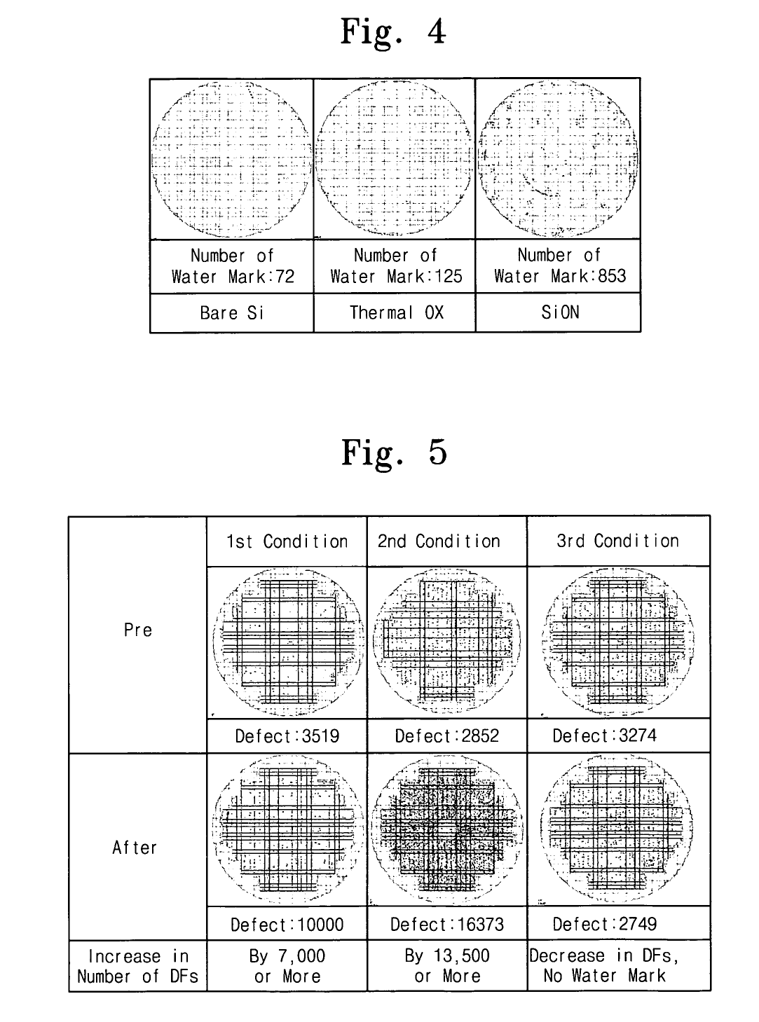

FIG. 4 is a plan view of various substrates illustrating the decreased number of water marks remaining on the substrates after being dried according to example embodiments. Referring to FIG. 4, tests were performed with substrates having a vulnerability to the occurrence of water marks. The substrates included a bare Si substrate, a thermal Ox substrate, and a SiON substrate. The tests revealed that the number of water marks was reduced with the drying method according to example embodiments. For example, with regard to the SiON substrate, the number of water marks was reduced by about 90% or more compared to a conventional drying process.

FIG. 5 is a plan view of various substrates illustrating the increased number of water marks remaining on the substrates after being dried under comparative conditions. Tests were performed on substrates having a vulnerability to the occurrence of water marks, wherein the substrates were shallow trench isolation (STI) pattern wafers. The STI pattern wafers were tested under three different conditions.

The first drying condition involved injecting deionized water from a drying nozzle onto a wafer while the wafer was being rotated at a relatively high speed. The second drying condition involved injecting a gas mixture from a drying nozzle at a relatively low pressure onto a wafer coated with a water film while the wafer was rotated at a speed of 100 rpm. The third drying condition involved injecting a gas mixture from a drying nozzle at a relatively high pressure onto a wafer coated with a water film while the wafer was rotated at a relatively low speed of 12 rpm according to example embodiments.

Because rotating speed of the wafer was relatively high in the first drying condition and the injection pressure of the gas mixture was relatively low in the second condition, the number of water marks on the dried wafer increased by about 10,000 or more in the first and second drying conditions. In contrast, because the wafer was rotated at about 12 rpm and the injection pressure of the gas mixture was relatively high, the number of water marks on the STI pattern wafer did not increase in the third drying condition according to example embodiments.

When a substrate is rotated at about 50 rpm or less, and IPA is supplied in the range of about 20 ml/min to about 30 ml/min, and the drying nozzle is moved in the range of about 1 mm/s to about 2 mm/s during drying, the number of water marks on the dried substrate may be reduced.

A method of treating a substrate according to example embodiments may include drying a substrate with only a carrier gas and an IPA nano mist. In contrast, in a conventional method, additional deionized water is injected by the drying nozzle during the drying step, thus requiring a larger amount of IPA to remove the deionized water. The method according to example embodiments does not require an additional supply of water in the drying step, because the water film formed on the surface of the substrate in the rinsing process is maintained for use in the drying process.

The substrate may be rotated at a relatively low speed such that the water film formed on the surface of the substrate is not dispersed from of the substrate by centrifugal force, but rather, the water film is removed by the drying gas. To avoid dispersing the water film by centrifugal force, the substrate may be rotated at a speed of about 50 rpm or less.

When supplying the drying gas mixture, the flow rate of the IPA may be maintained in the range of about 20 ml/min to about 30 ml/min. When the flow rate of the IPA in the gas mixture exceeds operating parameters, contaminants may be less likely to be removed from the surface of the substrate. The carrier gas and IPA may be supplied at flow rates of about 10 l/min and about 30 ml/min, respectively.

The supply line of the drying nozzle may be designed to have a diameter of about ⅛ inch or less to increase the injection pressure of the drying gas. For example, the supply line of the drying nozzle may be designed to have a diameter ranging from about ¼ inch to about ⅛ inch such that the injection pressure of the drying gas is about 2 or more times higher than conventional pressures. Thus, although the drying gas may be supplied to the surface of the substrate at a relatively low rate, the water on a patterned region of the substrate may still be removed relatively effectively by the higher injection pressure of the drying gas.

The substrate may include a substrate for a reticle, a substrate for a display panel (e.g., liquid crystal display panel, plasma display panel), a substrate for a hard disk, and a wafer for an electronic device (e.g., semiconductor device).

As described above, the number of water marks may be reduced by adjusting the fluid rate of IPA in the drying gas and the rotating speed of the substrate when drying the substrate. For example, although a substrate may be more prone to water marks when HF is used in the last stage of the cleaning step, the occurrence of water marks may be decreased rather significantly when drying according to example embodiments. Furthermore, satisfactory drying may be achieved regardless of surface characteristics of the substrate (e.g., presence of a pattern).

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A method of treating a substrate, comprising:
rinsing a surface of the substrate with water while rotating the substrate at a first speed followed by rotation at a second speed; and
drying the substrate by supplying a drying gas onto the surface of the substrate while rotating the substrate at a third speed of about 50 rpm or less.

2. The method of claim 1, wherein the water is deionized water.

3. The method of claim 1, wherein the first speed facilitates the dispersion of water from the surface of the substrate.

4. The method of claim 1, wherein the first speed ranges from about 500-600 rpm.

5. The method of claim 1, wherein the second speed facilitates the formation and maintenance of a film of water on the surface of the substrate.

6. The method of claim 5, wherein the film of water completely covers the surface of the substrate.

7. The method of claim 5, wherein the film of water shields the surface of the substrate from direct exposure to atmospheric air.

8. The method of claim 1, wherein the second speed is equal to the third speed.

9. The method of claim 1, wherein rinsing the surface of the substrate includes reducing the rotation of the substrate from a first speed to a second speed prior to completion of the rinsing, the second speed facilitating the formation and maintenance of a film of water on the surface of the substrate.

10. The method of claim 9, wherein the substrate is rotated at the second speed for about 5-10 seconds preceding completion of the rinsing.

11. The method of claim 1, further comprising:
maintaining a film of water on the surface of the substrate when commencing the drying of the substrate.

12. The method of claim 1, wherein the third speed is about 30 rpm or less.

13. The method of claim 1, wherein the third speed ranges from about 5-7 rpm.

14. The method of claim 1, wherein drying the substrate includes supplying the drying gas onto the surface of the substrate along a path extending from a center of the substrate to an edge of the substrate.

15. The method of claim 14, wherein the drying gas is supplied with a drying nozzle while moving the drying nozzle from the center of the substrate to the edge of the substrate.

16. The method of claim 15, wherein the drying nozzle is moved at a speed ranging from about 1-2 mm/s.

17. The method of claim 16, wherein the drying nozzle is moved at about 1 mm/s in a center portion of the substrate and at about 2 mm/s in an edge portion of the substrate.

18. The method of claim 1, wherein the drying gas includes a mixture of an isopropyl alcohol nano mist and a carrier gas.

19. The method of claim 18, wherein the isopropyl alcohol is supplied at a flow rate of about 30 ml/min and the carrier gas is supplied at a flow rate of about 10 l/min.

20. The method of claim 1, wherein the drying gas is supplied at a pressure ranging from about 1.5-3.5 g_{f}/cm².
